(19) United States
(12) Patent Application Publication
(10) Pub. No.: US 2026/0307875 A1
(43) Pub. Date: Oct. 8, 2026

(54) MULTI-LAYER, COEXTRUDED POLYESTER FILM WITH REDUCED PUNCTURE RESISTANCE, FOR USE AS BLISTER COVER FILM

(71) Applicant: Mitsubishi Polyester Film GmbH, Wiesbaden (DE)

(72) Inventors: Holger KLIESCH, Ginsheim (DE); Stephan AUDÖRSCH, Darmstadt (DE); Bodo KUHMANN, Runkel (DE); Matthias KONRAD, Kriftel (DE); Christine SCHMIEDESKAMP, Wiesbaden (DE)

(73) Assignee: Mitsubishi Polyester Film GmbH, Wiesbaden (DE)

(21) Appl. No.: 19/472,654

(22) PCT Filed: Apr. 2, 2024
(86) PCT No.: PCT/EP2024/058904

§ 371 Date: Oct. 4, 2025

(30) Foreign Application Priority Data
Apr. 5, 2023 (DE) 10 2023 108 752.5

(51) Int. Cl. B65D 75/36; B29C 48/00; B29C 48/08; B29C 48/21; B29K 67/00; B29L 31/00; B32B 27/08; B32B 27/20; B32B 27/36

(52) U.S. Cl. CPC B65D 75/36; B29C 48/022; B29C 48/08; B29C 48/21; B32B 27/08; B32B 27/20; B32B 27/36; B29K 2067/003; B29K 2995/0097; B29L 2031/7164; B32B 2250/02; B32B 2250/244; B32B 2264/303; B32B 2307/7376; B32B 2439/80

(57) ABSTRACT

The present invention relates to a multi-layer, coextruded polyester film with reduced puncture resistance, the use of the film as a cover film for blister packs, in particular pharmaceutical blisters (drug blisters) and the resulting closed blisters. The invention likewise relates to a process for producing the polyester film according to the invention.

The present invention relates to a multilayer, coextruded polyester foil with reduced puncture resistance, to the use of this foil as lidding foil for blister packs (below also referred to just as “blisters”), especially that of pharmaceutical blisters (drug blisters), and to the resultant closed blisters. The invention additionally embraces a process for the production of the polyester foil of the invention. The particular feature here is that the resultant blisters of the invention, when the foils described are used, can be opened by hand without tools, by pressing the packaged material through the lidding foil.

### DESCRIPTION

Blister packs are used today in many industries. One such pack consists of a shaped polymeric film (“formed part”) comprising one or more cavities, and a closure material. The closure material may be a welded-on foil web, or a paper web or a sealed-on foil web. The latter are a subject of the present invention, also referred to below as “lidding foil”.

In the drug packaging industry in particular, blisters of polymeric films (generally PVC, polyester or polypropylene, alternatively as single material or as composite material with layers of other materials, for instance oPA, aluminum or paper) with multiple cavities are employed. Typically, each cavity houses a tablet/capsule and the blister is closed on the back side with a foil web (see, for example, https://de.wikipedia.org/wiki/Sichtverpackung). Employed generally as closure material is an aluminum foil (generally 20-30 μm thick) having an applied sealing layer (sealing layer generally 3-5 μm thick). The aluminum foil is employed on account of its low puncture resistance, allowing the material within the cavity to be pressed through by hand.

Disadvantages of the existing solution include, however, the high surface weight of the aluminum foils, leading to high transport costs, and the high energy consumption associated with their production (large CO₂ footprint), and disadvantages, in particular, associated with the recycling of the aluminum foil blister packs entering the residual garbage. The overall proportion of the drug blisters in the residual garbage is relatively small, making it uneconomical generally for the aluminum to be sorted and reused (large-scale consumers such as hospitals are a theoretical exception). In the case of blisters with a formed part consisting of amorphous, unoriented polyester (APET), they could in theory be removed with other polyester wastes and subjected to chemical recycling via glycolysis. In that case, however, the aluminum still attached to the used blisters is a contaminant. The same applies to an alternative disposal route via pyrolysis of polypropylene-(PP) or PVC-based blisters.

In principle, such blisters can also be sealed not with aluminum foil but with polymeric foils. Especially suitable here are biaxially oriented foils of polyethylene terephthalate (PET), as even when not very thick they are stiff enough to be able to be applied to the blister without creases and, moreover, they can also be sealed effectively with the sealing tool temperatures of 120 to 240° C. that are typical on blister filling lines, without fusing with the sealing tool and remaining stuck to it on the contact side. Especially in the case of the faster blister lines where sealing takes place via sealing rolls, temperatures at the upper end of the stated range are employed.

Sealable polyester foils are described for example in DE102008046780, DE102008046781, EP2263868 or in EP1138480. The foils described in DE102008046781 generally seal, for example, to standard commercial PVC drug blisters, and those described in EP1138480 seal to standard commercial APET blisters. Disadvantages of all of these foils from the prior art, however, are that the tablet in the blister can be pressed through the sealed-on foil either not at all or only with extreme force effort. The resulting blister can then only be opened using tools (e.g., scissors).

The puncture resistance can in fact be reduced through controlled damage to the foil surface (for example, cuts into the surface made via bladed rolls or diecutting apparatuses) to an extent such that pressing through becomes possible. This, however, is a laborious additional operating step and also carries the risk of a tear developing in the foil simply on unintended bending of the blister by the user, with a worst-case scenario in which such a tear goes unnoticed and renders the contents unusable.

The object of the present invention was to provide a biaxially oriented polyester foil having low puncture resistance for use as lidding foil of a blister pack, said foil sealing to standard commercial formed blister parts made of APET or PVC and being amenable to processing on existing lines for pharmaceutical (medical) blisters and said foil allowing the packaged contents (especially tablets/capsules) to be pushed out and avoiding the above-described disadvantages, and also the provision of the blisters produced therefrom.

The object is achieved by a multilayer, coextruded polyester foil comprising an outer layer (A) and a base layer (B), wherein
(I) the outer layer (A) consists to an extent of at least 70% by weight of a polymer fraction which consists to an extent of at least 70% by weight of a copolyester which consists to an extent of 50 mol % of a dicarboxylic acid component and to an extent of 50 mol % of a diol component,
   wherein the copolyester derives from pure polyethylene terephthalate which consists to an extent of 50 mol % of ethylene glycol as diol component and to an extent of 50 mol % of terephthalic acid as dicarboxylic acid component,
   in which in total 15 to 50 mol % of the ethylene glycol and/or of the terephthalic acid is replaced by dicarboxylic acid components and/or diol components other than ethylene glycol and/or terephthalic acid;
(II) the base layer (B)
   (a) consists to an extent of at least 78% by weight of a polymer fraction which
      (i) consists to an extent of at least 70% by weight of a copolyester which consists to an extent of 50 mol % of a dicarboxylic acid component and to an extent of 50 mol % of a diol component,
         wherein the copolyester derives from pure polyethylene terephthalate which consists to an extent of 50 mol % of ethylene glycol as diol component and to an extent of 50 mol % of terephthalic acid as dicarboxylic acid component, in which in total 2 to 35 mol % of the ethylene glycol and/or of the terephthalic acid is replaced by dicarboxylic acid components and/or diol components other than ethylene glycol and/or terephthalic acid,
      (ii) consists to an extent of 0% to 30% by weight of a polymer incompatible with polyethylene terephthalate,
   (b) the base layer (B) contains 0% to 7% by weight of a particle having a mean particle diameter of d50≥1 μm, based on the total weight of the base layer (B),
   wherein the base layer (B) contains the incompatible polymer as per (ii) and/or the particles as per (b).

### Terms and Definitions

The terms “blister lidding foil”, “blister foil” and “lidding foil” are used synonymously below. A lidding foil is used to close a formed part, an operation typically accomplished by sealing.

The formed part of a blister pack serves to accommodate the contents of a blister pack. The formed part for this purpose is shaped by suitable thermoforming processes in such a way that the contents can be received by the cavities.

The terms “sealable”, “seal seam strength”, “heat sealing” and “sealing (on)” refer to the sealing procedure for closing the formed part with the blister lidding foil. The process is commonly one of heat sealing using pressure and heat. However, alternative methods, using ultrasound, for example, are also possible. For the purposes of the invention, the precise process is unimportant. The suitability of the lidding foil for sealing a formed part can only be indicated qualitatively, owing to the specific construction of a corresponding blister filling machine.

The term “foil stability” refers purely to the capacity for processing of a foil on its production or processing on a blister filling machine. Fast processing speeds require foils to have a certain degree of “stability”, essentially in order to withstand high tensile exposure. Biaxially oriented foils are generally good at meeting these requirements.

In the context of this invention, however, foil stability should not be confused with the property of the foil tearing easily during opening of the blister, even with minor mechanical exposure. For the consideration of tearing during opening of the blister, the term used is “puncture resistance”, which also constitutes an independent variable.

During the manual opening of the blister to remove the contents, it is usual to exert pressure on one of the cavities of the formed part using the thumb, so that the blister lidding foil is punctured by the contents. In normal language, the contents are “pressed through” the blister foil. This expression is likewise employed below.

Defined polyester varieties are used for producing the polyester foil, among them copolyester. Polyester structure is described with reference to the repeating units. Accordingly, a polyester is constructed in general of repeating units which arise from esterification of diols with dicarboxylic acids, the repeating units being present in linear concatenation in the molecule, and hence belong to the group of the thermoplastics. A repeating unit resulting from esterification of a diol with a dicarboxylic acid correspondingly contains a diol component, deriving from the diol used, and a dicarboxylic acid component, deriving from the dicarboxylic acid used. The term “comonomers” embraces not only the diol components but also the dicarboxylic acid components. Below, therefore, the terms “comonomer” and “diol/dicarboxylic acid component” are used synonymously. It means that comonomers stated in the context (both diols and dicarboxylic acids) are present in polymerized form in the polyester/copolyester. Amount-of-substance fractions of comonomers (comonomer fractions) are reported in this connection in mol % relative to the total amount of substance of the diol components and dicarboxylic acid components in the polyester/copolyester in question. The sum total of all the diol and dicarboxylic acid components in the polyester/copolyester is therefore 100 mol %, while the sum total of all diol components and dicarboxylic acid components in the polyester/copolyester is 50 mol % in each case.

Unless otherwise indicated, moreover, a copolyester is assumed to comprise a scaffold composed of ethylene units and terephthalate units, thus polyethylene terephthalate (PET). This is referred to as pure polyethylene terephthalate, as it consists to an extent of 50 mol % of terephthalic acid as dicarboxylic acid component and to an extent of 50 mol % of ethylene glycol as diol component. The meaning of this wording is that terephthalic acid is used for producing the polymer and the polymerized form of the terephthalic acid is present as dicarboxylic acid component in the copolymer. In the copolyesters of the invention, pure polyethylene terephthalate is assumed, with a certain amount of the ethylene glycol as diol component and/or of the terephthalic acid as dicarboxylic acid component having been replaced by comonomers other than ethylene glycol and/or terephthalic acid. Where a diol or dicarboxylic acid component can be derived from different monomers, the specific monomer used during polyester production is irrelevant. For example, the use of terephthalic acid (TPA) or of dimethyl terephthalate (DMT) results in the same terephthalate unit in the polyester.

A copolyester for the purposes of the invention may be a copolyester, a mixture of two or more copolyesters, or a mixture of one or more homopolymers and one or more copolymers. The sole restriction in this regard is that the copolyesters/copolyester mixtures present in the individual layers in total meet the requirements as in claim 1 with regard to the composition of the dicarboxylic acids and diols. For example, a mixture of the following copolyesters thus constitutes a copolyester of the invention provided the resulting mixture in total meets the requirements as per claim 1 with regard to the composition of the dicarboxylic acids and diols:
1. Polyethylene terephthalate raw material composed of ethylene glycol and terephthalic acid with an SV of 800 and 2% by weight of Irganox 1010 (BASF). The DEG content is 1.1 mol %, the IPA content <0.07 mol %;
2. Polyethylene terephthalate raw material composed of ethylene glycol and terephthalic acid with an SV of 800 and 1.5% by weight of SiO₂ particles having a d50 of 2.9 μm. The DEG content is 1.1 mol %, the IPA content <0.07 mol %;
3. Polyethylene terephthalate raw material composed of ethylene glycol, terephthalic acid and isophthalic acid with an SV of 800. The DEG content is 1 mol %, the IPA content 22 mol %.

From a puncture resistance of <4 N (see Measurement methods), an adult is able to open the blister by pressing the contents through. Preferably, however, the puncture resistance is <3.5 N and more preferably is <3 N and ideally is less than 2.7 N, since in that case the puncture resistance of typical 25 μm aluminum-based lidding foils presently used is attained.

The foils used are at least two-layer foils, having an outer layer A, which is sealable to the chosen blister material, and a base layer B. The foils of the invention are monoaxially or biaxially oriented foils, preferably biaxially oriented foils.

The sealable outer layer A (seal layer) is at least 1 μm thick, preferably at least 1.5 μm and very preferably at least 2 μm thick. The thicker the outer layer A, the stronger its sealing on the blister. As the outer layer A contributes little to the stability of the foil, moreover, at constant overall foil thickness, a thicker outer layer A is advantageous for achieving the low puncture resistances of the invention. Above 8 μm, however, there is no further improvement in adhesive strength. Since, though, the outer layer A likewise makes virtually no contribution to the stability of the foil during the foil production operation, thicknesses of the outer layer A of more than 3 μm and in particular more than 5 μm have proven less advantageous, as they afford no advantage for the sealing of the blisters and yet impair the producibility (increase in foil tears). The outer layer A therefore possesses a thickness of 1 μm to 8 μm, preferably 1.5 μm to 5 μm, more preferably of 2 μm to 3 μm.

The polyester foil of the invention may have a three-layer construction. In that case, further to the outer layer A and to the base layer B, the polyester foil comprises an additional outer layer C. The base layer B comprises a first and a second surface. The outer layer A is applied on one surface of the base layer B, and the outer layer C is applied on the other surface, facing away from the outer layer A, of the base layer B. The base layer B is disposed between the outer layers A and C, to produce an ABC foil structure.

The outer layer C is not sealable, consists predominantly (preferably to an extent of at least 80% by weight, more preferably to an extent of at least 90% by weight and ideally to an extent of at least 99% by weight) of a polyester which consists preferably to an extent of at least 92 mol % of polyethylene terephthalate or less preferably polyethylene naphthalate (more expensive and more difficult to produce), and preferably has very low comonomer fractions of <8 mol %, more preferably of <2.5 mol % and ideally of <1.8 mol %. Accordingly, for the outer layer C as well, pure polyethylene terephthalate (50 mol % ethylene glycol as diol component and 50 mol % terephthalic acid as dicarboxylic acid component) or pure polyethylene naphthalate (50 mol % ethylene glycol as diol component and 50 mol % naphthalic acid as dicarboxylic acid component) is assumed, with less than 8 mol % of the ethylene glycol and/or of the terephthalic acid or of the ethylene glycol and/or of the naphthalic acid being replaced by comonomers (diol and/or carboxylic acid components) other than ethylene glycol and/or terephthalic acid or than ethylene glycol and/or naphthalic acid. The comonomer fraction is therefore based on the sum total of the diol and/or dicarboxylic acid components other than ethylene glycol and/or terephthalic acid (on the basis of polyethylene terephthalate) or wherein the comonomer fraction is based on the sum of the diol and/or dicarboxylic acid components other than ethylene glycol and/or naphthalic acid (on the basis of polyethylene naphthalate). A low comonomer fraction leads to a low propensity to stick to the sealing tools of the blister filling line and hence leads to little deposition on these tools, thereby enabling prolonged disruption-free operation of the blister filling line. The outer layer C may additionally contain inorganic or organic pigments (particles such as, for example, SiO2, CaCO3, BaSO4, PMMA=crosslinked polymethyl methacrylate particles, etc.), having a mean particle size (d50) of more than 1 μm, of less than 1% by weight, preferably of <0.8% by weight and more preferably of <0.5% by weight. If the outer layer C has the stated low comonomer fractions and the low fraction of the stated particles, it makes a particularly high contribution to the stability of the foil and so facilitates the production of said foil, meaning that significantly fewer tears occur in the production operation. This is particularly effective if this outer layer C is at least 0.4 μm, preferably at least 0.6 μm and ideally at least 0.7 μm thick. If a low particle content and low comonomer fraction are present in the outer layer C, however, then beyond a thickness of 1.5 μm it significantly increases the puncture resistance. The outer layer C therefore preferably has a thickness of below 3 μm, more preferably of below 2.0 μm and ideally of below 1.7 μm.

In principle, structures having more than 3 layers are also possible. However, this generates no further advantages in the resulting blister and merely increases the production complexity, and is therefore less preferable.

The outer layer A contains a polymer fraction (mixture of one or more polymers), and other adjuvants which are not polymers. The polymer fraction of the outer layer A makes up at least 70% by weight, preferably at least 98% by weight, more preferably 99.5% by weight, ideally 99.7% by weight of the total weight of the outer layer A.

The polymer fraction of the outer layer A consists to an extent of at least 70% by weight, preferably to an extent of at least 85% by weight and more preferably to an extent of at least 90% by weight of a thermoplastic copolyester. With very particular preference, the polymer fraction of the outer layer A consists of a copolyester to an extent of 100% by weight.

The copolyester consists to an extent of 50 mol % of a dicarboxylic acid component and to an extent of 50 mol % of a diol component, the copolyester deriving from pure polyethylene terephthalate which consists to an extent of 50 mol % of ethylene glycol as diol component and to an extent of 50 mol % of terephthalic acid as dicarboxylic acid component. The copolyester is based on repeating units derived from ethylene glycol and terephthalic acid (=polyethylene terephthalate, PET). In the copolyester of the outer layer A, relative to pure PET, a total of 15 to 50 mol % of the ethylene glycol and/or of the terephthalic acid is replaced by dicarboxylic acid components and/or diol components other than ethylene glycol and/or terephthalic acid. Preferably, in the copolyester of the outer layer A, a total of 18 to 40 mol %, preferably 20 to 36 mol %, more preferably 22 to 34 mol % of the ethylene glycol and/or of the terephthalic acid has been replaced by dicarboxylic acid components and/or diol components other than ethylene glycol and/or terephthalic acid. The dicarboxylic acid components and/or diol components other than ethylene glycol and/or terephthalic acid are preferably selected from the group consisting of succinic acid, glutaric acid, pimelic acid, suberic acid, azelaic acid, sebacic acid, isophthalic acid, naphthalenedicarboxylic acid, adipic acid, furandicarboxylic acid, 1,4-cyclohexanedimethanol, diethylene glycol, neopentyl glycol, propanediol and butanediol, more preferably from the group consisting of isophthalic acid, naphthalenedicarboxylic acid, adipic acid, furandicarboxylic acid, 1,4-cyclohexanedimethanol, diethylene glycol, neopentyl glycol.

The composition of the copolyester in the outer layer A is dependent on the formed blister part onto which the polyester foil of the invention is to be sealed. For the sealing of polyester-based formed blister parts (e.g., kpNext™ R1 from Klöckner Pentaplast), it is preferable for the copolyester of the outer layer A to contain 15 to 50 mol %, preferably 18 to 32 mol %, more preferably 20 to 29 mol % and ideally 22 to 28 mol % of polyethylene isophthalate. Besides isophthalic acid (IPA), this polyester only contains 0 to 5 mol %, preferably 0.1 to 4 mol %, more preferably 0.1 to 3.5 mol % and very preferably 0.1 to 3 mol % of diethylene glycol (DEG) as further comonomer and 0 to 5 mol %, preferably 0 to 4 mol %, more preferably 0 to 3.5 mol % and very preferably 0 to 3 mol % of further comonomers. This means that 15 to 50 mol %, preferably 18 to 32 mol %, more preferably 20 to 29 mol % and ideally 22 to 28 mol % of the terephthalic acid in pure polyethylene terephthalate is replaced by isophthalic acid as dicarboxylic acid component, 0 to 5 mol %, preferably 0.1 to 4 mol %, more preferably 0.1 to 3.5 mol % and very preferably 0.1 to 3 mol % of the ethylene glycol is replaced by diethylene glycol as diol component, and a further 0 to 5 mol %, preferably 0 to 4 mol %, more preferably 0 to 3.5 mol % and very preferably 0 to 3 mol % of the ethylene glycol and/or of the terephthalic acid are replaced by dicarboxylic acid components and/or diol components which are other than ethylene glycol and/or terephthalic acid and are not isophthalic acid and diethylene glycol. The reason for this preference is that blisters of these kinds, with polyester-based formed part and polyester-based lidding foil, have particularly good recyclability. Since IPA and DEG are present anyway as comonomers in the majority of polyester recycling streams (e.g., in polyester bottle recyclate), these monomers do not disrupt the recycling. Conversely, different monomers, such as naphthalenedicarboxylic acid (NDC) or cyclohexanedimethanol, are more undesirable, as they are difficult or even impossible to remove during recycling and can lead to unwanted effects in the recyclate (NDC, for example, leads to a visible intrinsic fluorescence, and cyclohexanedimethanol to unwanted haze).

For the sealing of formed blister parts based on polyvinyl chloride (PVC) or PVC copolymers (e.g., Blis| Form from Liveo Research), it is preferable for the copolyester to contain 15 to 50 mol %, preferably 18 to 32 mol %, more preferably 20 to 29 mol % and ideally 22 to 28 mol % of 1,4-cyclohexanedimethanol (CHDM) or less preferably neopentyl glycol (NPG), or likewise less preferably to contain a combination of CHDM and NPG (in total to the ranges indicated above). In addition, there may be 0 to 10 mol %, preferably 0 to 8 mol %, more preferably 0 to 7 mol % and very preferably 0 to 6 mol % of further comonomers such as IPA or DEG and further comonomers as defined in this application present in the copolyester. This means that on the basis of pure polyethylene terephthalate, the stated mol % of the ethylene glycol and/or of the terephthalic acid have been replaced by the respective comonomers.

The content of comonomers in the polyester fraction of the outer layer A does not exceed 50 mol % and preferably is ≤40 mol % and more preferably is ≤36 mol %. With increasing comonomer content, the risk increases that the wound foil after production seals to the back side during storage and transport and can then no longer be unwound. Moreover, there is a fundamental desire for high fractions of PET in the recycling during the production of a polyester foil (edge trimmings and initial run, and also sorted rolls are recycled directly during foil production and are passed back to the operation) and in the recycling of the blisters used by the end customer.

The polymer fraction that is the balance to 100% by weight in the outer layer A, a maximum of 30% by weight based on the polymer fraction in the outer layer A, consists of different polymers. These are preferably polymers which are “incompatible”, i.e., immiscible, with the polyester, such as polyolefins or polymers and/or copolymers based on ethylene (e.g., LLDPE, HDPE and copolymers), propylene (PP), copolymers containing the repeating unit —[CH2-CHCH3]—, cyclic olefins (CO), amides (PA) or styrene (PS), preferably based on propylene (PP) and cyclic olefins (CO). The incompatible polymer used is preferably a copolymer. Examples thereof are C2/C3, C2/C4, C3/C4 and C2/C3/C4 copolymers, or copolymers based on cyclic olefins, such as norbornene/ethylene and tetracyclododecene/ethylene copolymers, for example. The incompatible polymer is more preferably a copolymer based on cyclic olefins (cyclic olefin copolymer (COC)) such as norbornene/ethylene and tetracyclododecene/ethylene copolymers, for example. Such cyclic olefin copolymers are described for example in EP-A 1 068 949 or in JP 05-009319, which are hereby referenced.

Among the cyclic olefin copolymers, especial preference is given to those which contain polymerized units of polycyclic olefins with norbornene substructure, more preferably norbornene or tetracyclododecene. Particularly preferred are cyclic olefin copolymers (COC) which contain polymerized units of acyclic olefins, especially ethylene. Especially preferred are norbornene/ethylene and tetracyclododecene/ethylene copolymers which contain 5% to 80% by weight of ethylene units, preferably 10% to 60% by weight of ethylene units (based on the mass of the copolymer).

The COCs generally have glass transition temperatures of between −20 and 400° C. For the outer layer A, preferred COCs are those having a glass transition temperature of less than 240° C., preferably less than 190° C. and more preferably less than 180° C. The glass transition temperature ought preferably to be above 50° C., more preferably above 55° C., more particularly above 60° C. Foils containing a COC having a glass transition temperature of less than 80° C. are notable relative to those containing a COC having a glass transition temperature of greater than 80° C. for a smaller reduction in the puncture resistance relative to the content of COC in the layer (unwanted). EP-A-0 283 164, EP-A-0 407 870, EP-A-0 485 893 and EP-A-0 503 422 describe the preparation of cyclic olefin copolymers (COCs) with catalysts based on soluble metallocene complexes. Particular preference is given to employing cyclic olefin copolymers produced with catalysts based on soluble metallocene complexes. Such COCs are available commercially: for example, Topas® (Ticona, Frankfurt). The addition of such incompatible polymers reduces the seal seam strength (unwanted) but also reduces the puncture resistance (desired).

Besides the polymer fraction, the outer layer A may consist to an extent of not more than 30% by weight, preferably to an extent of not more than 2% by weight, more preferably to an extent of not more than 0.5% by weight and ideally to an extent of not more than 0.3% by weight of other adjuvants, such as inorganic particles. These may be whitening particles such as titanium dioxide and barium sulfate, or particles consisting, for example, of calcium carbonate, silicon dioxide or aluminum trioxide. All of these adjuvants reduce the seal seam strength (unwanted), but particles having a mean particle size (d50) of more than 1 μm also reduce the puncture resistance (desired).

The base layer B contains a polymer fraction, and also, optionally, further adjuvants in particle form. The base layer B consists to an extent of at least 78% by weight of a polymer fraction comprising one or more thermoplastic polymers. To an extent of at least 70% by weight, preferably to an extent of at least 75% by weight and more preferably to an extent of at least 80% by weight, the polymer fraction of the base layer B contains a thermoplastic copolyester.

For the copolyester of the base layer B, the copolyester consists to an extent of 50 mol % of a dicarboxylic acid component and to an extent of 50 mol % of a diol component, the copolyester deriving from pure polyethylene terephthalate which consists to an extent of 50 mol % of ethylene glycol as diol component and to an extent of 50 mol % of terephthalic acid as dicarboxylic acid component. The copolyester is based on repeating units derived from ethylene glycol and terephthalic acid (=polyethylene terephthalate, PET). In the copolyester of the base layer B, relative to pure PET, a total of 2 to 35 mol %, preferably 3 to 18 mol %, more preferably 4 to 10 mol %, ideally 5 to 7 mol % of the ethylene glycol and/or of the terephthalic acid is replaced by dicarboxylic acid components and/or diol components other than ethylene glycol and/or terephthalic acid. The dicarboxylic acid components and/or diol components other than ethylene glycol and/or terephthalic acid are preferably selected from the group consisting of succinic acid, glutaric acid, pimelic acid, suberic acid, azelaic acid, sebacic acid, isophthalic acid, naphthalenedicarboxylic acid, adipic acid, furandicarboxylic acid, 1,4-cyclohexanedimethanol, diethylene glycol, neopentyl glycol, propanediol and butanediol, more preferably from the group consisting of isophthalic acid, naphthalenedicarboxylic acid, adipic acid, furandicarboxylic acid, 1,4-cyclohexanedimethanol, diethylene glycol, neopentyl glycol.

The preferred comonomers here are isophthalic acid and diethylene glycol, as they do not disrupt the recycling of the finished blisters.

Surprisingly it has emerged that a foil with a base layer B which contains a comonomer fraction as described above, in combination with the incompatible polymers and/or particles of d50 ≥1 μm that are described later on below, requires a lower puncture force than a foil with a base layer B having a smaller fraction of such comonomers, although these comonomers ought typically to lead to improved deformability of the foil and hence to poorer puncture characteristics.

If, however, the comonomer content becomes too great, the foil is excessively deformable and so hinders the opening of the blister by pressing through by hand. Moreover, as the comonomer fraction increases, there is a rise in the contraction of the foil, which may in particular critically disrupt the operation of the blister filling machine. The comonomer fraction in the base layer B is therefore ≤35 mol %, preferably ≤25 mol %, more preferably ≤18 mol % and ideally≤12 mol %. In the case of an only two-layer structure, the comonomer fraction is always≤12 mol %, preferably ≤10 mol %, more preferably ≤8 mol % and ideally≤7 mol %. In a two-layer structure, an increasing comonomer fraction is accompanied by a rise in the risk of sticking of the non-sealable foil surface to the sealing tools of the blister filling line and in the propensity to formation of deposits on these tools.

Besides the copolyester, the base layer B contains either a polymer incompatible with the copolyester or 0.2% to 7% by weight of a particle having a particle diameter of d50>1 μm, or a combination of polymer incompatible with the copolyester and a particle having a particle diameter of d50>1 μm.

The incompatible polymer results in a lower density of the foil, which reduces the surface weight and hence the amount of foil per blister. This leads to a better CO2 balance. Moreover, as its fraction increases, the incompatible polymer lowers the puncture force. With increasing content, in particular of above 25% by weight and particularly strongly above 30% by weight, the producibility of the foil (smooth running) becomes much more difficult (tears in foil production). The content of incompatible polymer is therefore ≤30% by weight, preferably ≤25% by weight. At below 2% by weight and particularly below 0.5% by weight, the contribution of the incompatible polymer to the reduction in puncture resistance becomes virtually nil.

The polymer being “incompatible” means that it is immiscible with the polyester. The polymers in question are polymers and/or copolymers based on ethylene (e.g., LLDPE, HDPE), propylene (PP), cyclic olefins (CO), amides (PA) or styrene (PS), preferably based on propylene (PP) and cyclic olefins (CO). The incompatible polymer used is preferably a copolymer. Examples thereof are C2/C3, C2/C4, C3/C4 and C2/C3/C4 copolymers, or copolymers based on cyclic olefins, such as norbornene/ethylene and tetracyclododecene/ethylene copolymers, for example. The incompatible polymer is more preferably a copolymer based on cyclic olefins (cyclic olefin copolymer (COC)) such as norbornene/ethylene and tetracyclododecene/ethylene copolymers, for example. Such cyclic olefin copolymers are described for example in EP-A 1 068 949 or in JP 05-009319, which are hereby referenced. The COCs have the advantage over polyethylene-based polymers (polymers based on ethylene (LLDPE, HDPE), C2/C4 copolymers, C2/C3/C4 copolymers) that, at the extrusion temperature needed for PET, they do not suffer such severe degradation and therefore have less of a propensity to form gel. This advantage also exists (albeit to a lesser extent) over polypropylene-based polymers (PP). PP and copolymers based on PP have a propensity to relatively severe yellowing in the foil, which is undesirable, and to relatively severe emission of odor during foil production, which is likewise undesirable.

Among the cyclic olefin copolymers, a special preference is given to those which contain polymerized units of polycyclic olefins with norbornene substructure, more preferably norbornene or tetracyclododecene. Particularly preferred are cyclic olefin copolymers (COC) which contain polymerized units of acyclic olefins, especially ethylene. Especially preferred are norbornene/ethylene and tetracyclododecene/ethylene copolymers which contain 5% to 80% by weight of ethylene units, preferably 10% to 60% by weight of ethylene units (based on the mass of the copolymer).

The COCs generally have glass transition temperatures of between-20 and 400° C. Preferred for the invention are cyclic olefin copolymers (COCs) which have a glass transition temperature of greater than 70° C., more preferably greater than 90° C. and more particularly greater than 130° C. The lower the glass transition temperature is from 130° C. downward, the lower the reduction in puncture resistance relative to the amount of COC added. In other words, more COC is needed in order to attain the low puncture resistances of the invention. If the glass transition temperature is above 200° C., there is a rise in the pressure on extrusion during production of the foils, leading to reduced service lives of the melt filters used: consequently, COCs having a glass transition temperature of greater than 200° C. are less preferable.

The base layer B may, in place of the incompatible polymer, contain particles having a d50≥1 μm. The particles have a d50≥1 μm, preferably ≥1.5 μm and more preferably ≥2 μm. Smaller particles cause virtually no reduction in puncture resistance, and therefore only introduce unwanted non-polyester material and so reduce the capacity for regeneration. The particles have a d50 of ≤8 μm, preferably ≤6 μm and more preferably ≤5 μm. While larger particles do increase the reduction in puncture resistance for the same concentration (desirable), they also impair the smooth running and hence the producibility of the foils (unwanted).

The particles used are preferably silicate-based particles (SiO2, aluminum silicates, etc.); likewise suitable are aluminum oxides, and particles of crosslinked PMMA (less preferable, as they are expensive and require higher added amounts); less preferred are particles based on barium sulfate, titanium dioxide or calcium carbonate, as more particles are needed by comparison with the preferred silica particles, and this adversely affects the smooth running during foil production. Contents of below 0.3% by weight and more particularly of below 0.2% by weight for the stated particles make virtually no further contribution to the reduction in puncture resistance.

The base layer B may contain, besides the copolyester, both a polymer incompatible with PET and particles having a d50≥1 μm (as defined above). The combination enables the low puncture force of the invention to be achieved particularly effectively and at the same time, owing to the lower concentrations of the individual components, allows the negative effect on smooth running during foil production to be optimized.

Where the base layer B contains both a polymer incompatible with PET and particles having a d50≥1 μm, the fraction of incompatible polymer in the base layer is 4% to 17% by weight, preferably 12% to 16% by weight (based on the polymer fraction in the base layer B). The fraction of particles having a d50>1 μm in this case is 1.0% to 3.0% by weight and preferably 1.7% to 2.2% by weight (based on the total weight of the base layer B).

In accordance with the invention, the polymer fraction of the base layer B consists to an extent of 0.5% to 30%, preferably to an extent of 2% to 25% by weight of a polymer incompatible with polyethylene terephthalate and the base layer B contains 0% by weight of a particle having a mean particle diameter of d50>1 μm, or
the polymer fraction of the base layer B consists to an extent of 0% by weight of a polymer incompatible with polyethylene terephthalate and the base layer B contains 0.2% to 7%, preferably 1.0% to 3.0% by weight of a particle having a mean particle diameter of d50>1 μm, or
the polymer fraction of the base layer B consists to an extent of 4% to 17%, preferably to an extent of 12% to 16% by weight of a polymer incompatible with polyethylene terephthalate and the base layer B contains 1.0% to 3.0%, preferably 1.7% to 2.2% by weight of a particle having a mean particle diameter of d50 >1 μm.

Besides the stated ingredients, the base layer B may consist to an extent of not more than 15% by weight, preferably to an extent of not more than 2% by weight, more preferably to an extent of not more than 0.5% by weight and ideally to an extent of not more than 0.3% by weight of other adjuvants, such as inorganic particles or different polymers. These may be whitening particles such as titanium dioxide (may be desirable in a particular embodiment with relatively high whiteness, as light and UV protection) and barium sulfate, or smaller particles (d50<1 μm) which consist, for example, of calcium carbonate, silicon dioxide or aluminum trioxide. All of these adjuvants reduce the smooth running during foil production and disrupt the recycling, and are therefore less desirable.

In the layers with a comonomer fraction of min. 2 mol %, it has proven advantageous if 100 to 5000 ppm of an antioxidant (radical scavenger) are included in this layer as a further adjuvant. The antioxidant prevents excessive degradation of the polymers during extrusion and hence is advantageous for the smooth running. The antioxidant, however, tends to raise the puncture force, which is undesirable, and hence the fraction of antioxidant is preferably below 3000 ppm, more preferably below 2000 ppm and ideally below 1500 ppm. Where the fraction of comonomer is below 2 mol %, the addition of antioxidants provides no advantages for the smooth running, but continues to bring disadvantages owing to increasing puncture force, and is therefore less preferable.

The overall foil thickness is at least 5 μm and not more than 50 μm. The thicker the foil, the more difficult it becomes to attain the maximum puncture resistance of the invention with the foils described below. Foil thicknesses above 30 μm are therefore rational only if a puncture resistance in the upper range of the invention is the intended goal. This is the case, for example, if the blister is to be more difficult for children to open. The low puncture resistances can be achieved particularly effectively with the foil structures of the invention at thicknesses below 25 μm, better still at below 20 μm, and ideally at foil thicknesses of below 18 μm. As a result, the surface weight (that is, the amount of foil per blister) also drops and hence there is also a drop in the CO2 footprint. Below 20 μm foil thickness, in particular, with the typical processing speeds of the lines for filling and sealing blister packs and with the typical sealing temperatures and short sealing times, the passage of heat through the foil into the sealing layer is large enough to melt this layer and to ensure effective sealing.

Below 5 μm, the foils of the invention can no longer be economically produced, as under the production conditions they already become so fragile that there are an intolerably high number of film tears in the production operation. The same also applies to the subsequent operation of slitting to the foil widths used on the blister filling lines. The application and sealing of the foils on these blister filling lines also becomes increasingly difficult (creasing and tears) as the thickness reduces. It is therefore preferred to use foils of at least 8, more preferably of at least 11 μm and ideally of at least 13 μm in overall thickness. With a higher foil thickness, moreover, the seal layer can be produced economically with greater thickness, since with conventional three-layer polyester foil lines the output per unit area reaches an optimum when each of the outer layers accounts for about 10% of the overall thickness.

In accordance with the invention, the overall foil thickness for the polyester foil is 8 μm to 25 μm, preferably 11 μm to 20 μm, more preferably 13 μm to 18 μm.

The foil preferably has a density of ≤1.15 g/cm³, more preferably of ≤1.08 g/cm³ and ideally of ≤0.98 g/cm³. As well as the advantage already mentioned, of the surface weight which is then lower, the lidding foil can then, during the recycling, be detached from the blister only in a heated alkaline water bath and then floats (with the bath adjusted to appropriate density) at the top, while blisters based both on A-PET and on PVC sink, allowing the two fractions to be parted and recycled separately, with the recycling of the lidding foil taking place ideally via chemical recycling. The A-PET blister can then be recycled both chemically and mechanically. These low densities are achieved through addition of incompatible polymer to the base layer B, and also by observing the maximum thicknesses for the layers A and optionally C, and through the biaxial orientation applied as part of the film production operation.

The foil preferably has an elasticity modulus in both foil directions (TD and MD) of ≥2200 N/mm² and more preferably of ≥2500 N/mm² in longitudinal and transverse directions. The elongation at break (DIN EN ISO 527-1 and -3) in both foil directions is preferably >30%, more preferably >50% and ideally ≥60%. The higher the elongation at break, the lower the tendency for tearing in production or processing (e.g., narrow slitting). If the elasticity moduli are above the stated limits, the foil can be processed particularly effectively on the blister filling lines, since under tension it does not stretch unduly and remains readily guidable. Moreover, the foil does not stretch excessively on puncture and so facilitates manual pressing through. If the elasticity moduli in both foil directions (TD and MD) have values of above 3800, or even of above 4000 N/mm², then the foil stretches less on manual puncture and the required puncture force goes up. Consequently, the elasticity moduli in both foil directions are preferably above 2200 and below 4000 N/mm² and more preferably between 2500 and 3800 N/mm². These mechanical properties can be established and maintained through the formulations according to the invention and by varying the parameters for the biaxial orientation of the foil within the process conditions indicated below.

The foil in longitudinal direction preferably has a shrinkage at 150° C. of ≤3%, more preferably of ≤2.5% and ideally of ≤1.8%. At 180° C., the foil in longitudinal direction preferably has a shrinkage of ≤4%, more preferably of ≤3.7% and ideally of ≤3.5%. In transverse direction, the foil preferably has a shrinkage at 150° C. of ≤1.8%, more preferably of ≤1.5% and ideally of ≤1.2%. At 180° C., the foil in transverse direction preferably has a shrinkage of ≤3.3%, more preferably of ≤2.8% and ideally of ≤2.5%. A low shrinkage is preferred since the film is sealed onto the blister at temperatures above 120° C. and frequently even above 150° C. If the shrinkage is too high, the resultant blisters at relatively high sealing temperatures are no longer flat but instead are curved and so are more difficult to pack. This is especially the case when the shrinkage in transverse direction is too high, since the film in longitudinal direction is still hindered from shrinking by the web tension. The preferred shrinkage values are adjusted via the setting temperatures and the convergence in the foil production operation, and also by observance of the maximum comonomer contents.

The foil may be coated with the typical processes both during the production operation (see below) and thereafter (referred to as off-line operation). A print pretreatment is applied in particular to the non-sealable side. Suitable print pretreatments are, for example, acrylate-based as described in EP1916096, or preferably based on water-soluble copolyesters, as described for example in US2021331455 (principally for water-based printing inks). The print pretreatment facilitates printing with product information, for example.

### Process for Producing the Lidding Foil

The polyester polymers of the individual layers are produced by polycondensation according to known processes.

The particles may be added during the actual production of the polyester. To that end, the particles are dispersed in the diol, optionally ground, decanted and/or filtered, and added to the reactor, in either the (trans) esterification or the polycondensation step. This method, however, is associated with much higher production costs for the masterbatch, relative to the method which follows.

Preferably, a concentrated, particle-containing polyester masterbatch can be produced with a gentle twin-screw extruder and diluted with particle-free polyester during foil extrusion. This is the preferred method, being more cost-effective.

The present invention embraces a process for producing a polyester foil of the invention, characterized in that the polymers for the individual layers of the foil are melted in a plurality of extruders, the resulting melts are shaped to flat melt films in a multilayer die, are pressed through a slot die, and are drawn off on a chill roll and one or more takeoff rolls, with the polyester foil cooling and solidifying and being then biaxially oriented, subsequently heat-set and then wound up, characterized in that
(I) the outer layer (A) consists to an extent of at least 70% by weight of a polymer fraction which consists to an extent of at least 70% by weight of a copolyester which consists to an extent of 50 mol % of a dicarboxylic acid component and to an extent of 50 mol % of a diol component,
   wherein the copolyester derives from pure polyethylene terephthalate which consists to an extent of 50 mol % of ethylene glycol as diol component and to an extent of 50 mol % of terephthalic acid as dicarboxylic acid component,
   in which in total 15 to 50 mol % of the ethylene glycol and/or of the terephthalic acid is replaced by dicarboxylic acid components and/or diol components other than ethylene glycol and/or terephthalic acid;
(II) the base layer (B)
(a) consists to an extent of at least 78% by weight of a polymer fraction which
   (i) consists to an extent of at least 70% by weight of a copolyester which consists to an extent of 50 mol % of a dicarboxylic acid component and to an extent of 50 mol % of a diol component,
      wherein the copolyester derives from pure polyethylene terephthalate which consists to an extent of 50 mol % of ethylene glycol as diol component and to an extent of 50 mol % of terephthalic acid as dicarboxylic acid component,
      in which in total 2 to 35 mol % of the ethylene glycol and/or of the terephthalic acid is replaced by dicarboxylic acid components and/or diol components other than ethylene glycol and/or terephthalic acid,
   (ii) consists to an extent of 0% to 30% by weight of a polymer incompatible with polyethylene terephthalate,
(b) the base layer (B) contains 0% to 7% by weight of a particle having a mean particle diameter of d50≥1 μm, based on the total weight of the base layer (B),
wherein the base layer (B) contains the incompatible polymer as per (ii) and/or the particles as per (b).

Where the base layer B contains particles having a mean particle diameter of d50≥1 μm, it is preferable, before the melting of the polymers in the extruders, to produce a particulate polymer which contains the particles having a mean particle diameter of d50 ≥1 μm of the base layer B and to mix it, during the melting in the extruder, with particle-free polyester of the base layer B.

The incompatible polymer, if present, is preferably added to the extruder directly during film production. Supplying it via a masterbatch of the incompatible polymer in a polyester is less preferable, as it results in smaller domains of the incompatible polymer in the foil, which lead to a higher puncture force than in the case of direct addition; this is undesirable.

First of all, the polymer mixtures along with further adjuvants of the individual layers are compressed and liquefied in extruders. In one preferred embodiment, the melt temperatures (temperature measured in the melt at the extruder outlet) are between 290° C. and 300° C. At temperatures above 300° C., the yellowness index increases; at temperatures below 290° C., there is an increased risk of unmelted polymer fractions, which can lead to unwanted surface elevations in the resulting foil. This temperature is established via the throughput-to-rotation ratio of the extruder, and/or via the temperatures of the extruder heater. These respective ratios and temperatures are to be established by the skilled person as a function of the type of extruder employed. The melts are then shaped to flat melt films in a multilayer die, pressed through a slot die, and drawn off on a chill roll and one or more takeoff rolls, where it cools and solidifies.

The foil of the invention is biaxially oriented, i.e., biaxially stretched. The biaxial stretching of the foil is most frequently performed sequentially. In that case, stretching takes place preferably first in longitudinal direction (i.e., in machine direction, =MD) and subsequently in transverse direction (i.e., perpendicularly to the machine direction, =TD). The stretching in longitudinal direction can be performed by means of two rolls which rotate at different speeds according to the target stretching ratio. For the transverse stretching, a corresponding tenter frame is generally utilized. The longitudinal stretching ratio is in the range from 2.5:1 to 6:1, preferably from 2.8:1 to 4.5:1. A stretching ratio above 4.5:1 results in significantly impaired producibility (tears). The transverse stretching ratio is generally in the range from 2.5:1 to 5.0:1, preferably from 3.2:1 to 4.0:1. Through the choice of suitable stretching parameters, the skilled person is able to adjust the mechanical properties of the foil, such as elasticity modulus and extensibility. In one preferred embodiment, the stretching ratio here in both foil directions is more than 2:1, more preferably above 2.5:1 and ideally above 3:1. The higher the surface stretching ratio (stretching ratio longitudinal times transverse), the lower the resultant puncture force and, when using incompatible polymer, the lower the resultant density. In one preferred embodiment, the stretching ratios do not exceed 5.5:1 in any foil direction, more preferably 5:1 in any foil direction and ideally 4.7:1 in any foil direction, since, while higher stretching ratios do further reduce the puncture force, they unnecessarily complicate foil producibility as a result of numerous tears during production. The surface stretching ratio (stretching ratio longitudinal times transverse) is therefore preferably at least 10:1, more preferably at least 10.5:1 and ideally at least 10.8:1, and is preferably <21:1 and more preferably <18:1 and ideally <15:1.

The temperature at which the stretching is performed may vary within a relatively wide range and is guided by the desired properties of the foil. In general, the stretching is performed in longitudinal direction in a temperature range from 80° C. to 130° C. (heating temperatures 80° C. to 130° C.) and in transverse direction in a temperature range from 90° C. (beginning of stretching) to 140° C. (end of stretching). To attain the desired foil properties, it has proven advantageous if the stretching temperature (in MD and TD) is less than 125° C. and preferably less than 118° C. Prior to the transverse stretching, one or both surfaces of the foil may be coated in-line by processes known per se. In one preferred embodiment, the foil is uncoated on the sealable side (outer layer A).

In the subsequent heat-setting, the foil is held under tension at a temperature of 150° C. to 250° C. over a duration of about 0.1 s to 10 s. For achieving the desired shrinkage values, setting temperatures are preferably at least 215° C., more preferably at least 220° C. and ideally at least 225° C. At the end of setting, the foil is relaxed at temperatures of 200 to 130° C. (ideally at temperatures of 190 to 150° C.) by the establishment of convergence (reduction in frame width) of preferably at least 2%, more preferably at least 3% and ideally at least 3.5%. The shrinkage values are further reduced in this way. The foil is subsequently wound in a conventional manner.

The regrind arising in foil production can be supplied to all the layers. Preferably, however, the regrind is supplied only to the base layer.

As a proportion of the overall foil thickness, the fraction of the base layer is therefore preferably at least 50%, more preferably at least 65% and very preferably at least 75%. This facilitates economic return of the regrind arising.

### Production of the Blisters of the Invention

The present invention further embraces the use of the polyester foil of the invention as lidding foil for a blister pack.

The blisters are sealed on standard commercial blister filling lines such as, for example, the BEC 200 or BEC 300 from Uhlmann Pac-Systeme Gmbh & Co. KG (Uhlmannstraβe 14-18, 88471 Laupheim, Germany). Shaping of the blister film into the formed part takes place generally on the same line which also fills and seals the blisters. Alternatively, however, preformed blisters may also be supplied. The lidding foil is supplied to the previously formed blister film (including the material present that is to be packaged into the cavities, such as tablets (solid product)) and is sealed onto the blister film via plate sealing or preferably via roll sealing at temperatures of 120-240° C.

The present invention likewise embraces a blister pack consisting of a preshaped film for accommodating solid products and a lidding foil consisting of the polyester foil of the invention.

### Usage

The articles (e.g., coated or uncoated tablets) enclosed in the blisters sealed with the foils of the invention can be removed from these blisters by pressing through by hand. The blisters produced are therefore very suitable for medical/pharmaceutical packaging applications, but also suitable for other materials, such as chewing gum pieces, batteries, etc.

### Analysis

The raw materials and the foils were characterized using the following measurements:

### Measurement of Mean Particle Diameter d₅₀

The diameter of the particles is determined using a Malvern Master Sizer 2000.

This is done by placing the samples into a cuvette with isopropanol and then placing the cuvette into the instrument. The dispersion is analyzed via laser and the signal is used to determine the particle size distribution by comparison with a calibration plot.

SEM or TEM measurements on the foil produced by means of these particles show a mean particle diameter which is on average lower by 15-25% than the particles used. The particle diameter of the particles in the foil can therefore be calculated from the particle diameters of the particles used for producing the foil.

### Mechanical Properties

The mechanical properties were determined via tensile testing on the basis of DIN EN ISO 527-1 and -3 (type 2 specimens) on foil strips measuring 100 mm×15 mm.

### Puncture Resistance

The required force for puncture and also the elongation on puncture are ascertained by way of the puncture resistance test according to DIN EN 14477:2004. For this test, sample strips around 30 cm in length and around 2.5 cm in width are cut. In deviation from the standard, 5 individual measurements are carried out on these strips, with the spacing between the measurement points being at least 1.5 cm. The testing velocity is 100 mm/min. The samples are punctured from the seal side.

### Evaluation of Smooth Running

The foil is produced on a line for producing biaxially oriented polyester foils with a final foil width of at least 1 m. Each formulation is produced for 12 hours, with the final foil velocity being at least 50 m/min. The number of tears is counted (tears due to external events, such as power failures, which have no direct link to foil production are subtracted).

Smooth running is considered very good (++) for <2 tears, good (+) for 2-3, adequate (0) in the case of 4-5, and poor (−) in the case of >5.

### Examples

### Foil Production

The polymer mixtures are melted at 292° C. and placed electrostatically through a slot die onto a chill roll conditioned at 50° C. This is followed by longitudinal and then transverse stretching under the following conditions:

| | | | |
|---|---|---|---|
| Longitudinal | Heating temperature | 75-115 | ° C. |
| stretching | | | |
| | Stretching temperature | 115 | ° C. |
| | Longitudinal stretching ratio | 3.2 | |
| Transverse | Heating temperature | 100 | ° C. |
| stretching | | | |
| | Stretching temperature | 112 | ° C. |
| | Transverse stretching ratio | 3.9 | |
| | (including 1st setting zone | | |
| | stretching) | | |
| Setting | Temperature | 232-150 | ° C. |
| | Time | 3 | s |
| Setting | Temperature of 1st setting zone | 170 | ° C. |
| | Temperature at which | 180 and 150 | ° C. |
| | relaxation takes place | | |

Raw materials employed in the examples are as follows:

PET1=polyethylene terephthalate raw material made from ethylene glycol and terephthalic acid with an SV of 820. The DEG content is 1 mol %, the IPA content is <0.05 mol %

PET2=polyethylene terephthalate raw material made from ethylene glycol, terephthalic acid and isophthalic acid with an SV of 800.

The DEG content is 1 mol %, the IPA content is 11 mol %

PET3=polyethylene terephthalate raw material made from ethylene glycol, terephthalic acid and isophthalic acid with an SV of 450 and 15% by weight of SiO₂ with a d50 of 3.5 μm. The silicon dioxide particle was incorporated into the polymer in a twin-screw extruder.

The DEG content is 1.2 mol %, the IPA content is 11 mol %

PET4=polyethylene terephthalate raw material made from ethylene glycol and terephthalic acid with an SV of 800 and 2% by weight of Irganox 1010 (BASF). The Irganox was incorporated into the polymer in a twin-screw extruder.

The DEG content is 1.1 mol %, the IPA content is <0.07 mol %

PET5=polyethylene terephthalate raw material made from ethylene glycol and terephthalic acid with an SV of 800 and 1.5% by weight of SiO₂ particles with a d50 of 2.9 μm. The silicon dioxide particle was added during the polycondensation.

The DEG content is 1.1 mol %, the IPA content is <0.07 mol %

PET6=polyethylene terephthalate raw material made from ethylene glycol and terephthalic acid with an SV of 800 and 1.9% by weight of SiO₂ particles with a d50 of 0.4 μm. The silicon dioxide particle was added during the polycondensation.

The DEG content is 1.1 mol %, the IPA content is <0.07 mol %

PET7=polyethylene terephthalate raw material made from ethylene glycol, terephthalic acid and isophthalic acid with an SV of 800.

The DEG content is 1 mol %, the IPA content is 22 mol %

PET8=polyethylene terephthalate raw material made from ethylene glycol, terephthalic acid and 1,4-cyclohexanedimethanol (CHDM) with an SV of 790.

The DEG content is 0.5 mol %, the CHDM content is 33 mol %

### Incompatible Polymer 1

COC Topas 6015 (manufacturer: Topas Advanced Polymers GmbH Germany), Glass transition temperature=158° C.

### Incompatible Polymer 2

COC 9903D-10 (manufacturer: Topas Advanced Polymers GmbH Germany), glass transition temperature=33° C.

### Formulations

| | | E1 | E2 | E3 | E4 | E5 | E6 | E7 | E8 | E9 | E10 | E11 | CE1 | CE2 |
|---|---|---|---|---|---|---|---|---|---|---|---|---|---|---|
| | Thickness A | 2 | 2 | 2 | 2 | 2 | 2 | 2 | 2 | 2 | 2 | 2 | 2 | 2 |
| | Thickness B | 5.2 | 11.5 | 16.5 | 26.5 | 16.5 | 11.5 | 11.5 | 11.5 | 11.5 | 11.5 | 13 | 56.5 | 11.5 |
| | Thickness C | 0.8 | 1.5 | 1.5 | 1.5 | 1.5 | 1.5 | 1.5 | 1.5 | 1.5 | 1.5 | 0 | 1.5 | 1.5 |
| | Foil thickness | 8 | 15 | 20 | 30 | 20 | 15 | 15 | 15 | 15 | 15 | 15 | 60 | 15 |
| A - | PET1 | | | | | | | | | | | | | |
| layer | PET2 | | | | | | | | | | | | | |
| | PET3 | | | | | | | | | | | | | |
| | PET4 | 4 | 4 | 4 | 4 | 0 | 4 | 4 | 4 | 4 | 4 | 4 | 4 | 4 |
| | PET5 | 3 | 3 | 3 | 3 | 3 | 3 | 3 | 3 | 3 | 3 | 3 | 3 | 3 |
| | PET6 | | | | | | | | | | | | | |
| | PET7 | 93 | 93 | 93 | 93 | 97 | | 93 | 93 | 93 | 93 | 93 | 93 | 93 |
| | PET8 | | | | | | 93 | | | | | | | |
| | Incompatible | | | | | | | | | | | | | |
| | polymer 1 | | | | | | | | | | | | | |
| | Incompatible | | | | | | | | | | | | | |
| | polymer 2 | | | | | | | | | | | | | |
| | PP | | | | | | | | | | | | | |
| B - | PET1 | 19 | 19 | 19 | 19 | 24 | 19 | 22 | 21 | 19 | 19 | 19 | 19 | 30 |
| layer | PET2 | 50 | 50 | 50 | 50 | 50 | 50 | 37 | 50 | 50 | 50 | 50 | 50 | 0 |
| | PET3 | 12 | 12 | 12 | 12 | 12 | 12 | 36 | 0 | 12 | 12 | 12 | 12 | 0 |
| | PET4 | 5 | 5 | 5 | 5 | 0 | 5 | 5 | 5 | 5 | 5 | 5 | 5 | 5 |
| | PET5 | | | | | | | | | | | | | |
| | PET6 | | | | | | | | | | | | | 60 |
| | PET7 | | | | | | | | | | | | | |
| | PET8 | | | | | | | | | | | | | |
| | Incompatible | 14 | 14 | 14 | 14 | 14 | 14 | 0 | 24 | 0 | 0 | 14 | 14 | 5 |
| | polymer 1 | | | | | | | | | | | | | |
| | Incompatible | | | | | | | | | 14 | | | | |
| | polymer 2 | | | | | | | | | | | | | |
| | PP | | | | | | | | | | 14 | | | |
| C - | PET1 | 95 | 95 | 95 | 95 | 95 | 95 | 95 | 95 | 95 | 95 | | 95 | 95 |
| layer | PET2 | | | | | | | | | | | | | |
| | PET3 | | | | | | | | | | | | | |
| | PET4 | | | | | | | | | | | | | |
| | PET5 | 5 | 5 | 5 | 5 | 5 | 5 | 5 | 5 | 5 | 5 | | 5 | 5 |
| | PET6 | | | | | | | | | | | | | |
| | PET7 | | | | | | | | | | | | | |
| | PET8 | | | | | | | | | | | | | |
| | Incompatible | | | | | | | | | | | | | |
| | polymer 1 | | | | | | | | | | | | | |
| | Incompatible | | | | | | | | | | | | | |
| | polymer 2 | | | | | | | | | | | | | |
| | PP | | | | | | | | | | | | | |

### Properties According to the Invention

| | | E1 | E2 | E3 | E4 | E5 | E6 | E7 |
|---|---|---|---|---|---|---|---|---|
| Shrinkage | MD | 1.8 | 1.9 | 1.8 | 1.7 | 1.8 | 1.7 | 2.3 |
| 150° C. [%] | TD | 1 | 1 | 1 | 1.1 | 1 | 1 | 1.5 |
| Shrinkage | MD | 2.3 | 2.4 | 2.2 | 2.4 | 2.3 | 2.3 | 3.1 |
| 180° C. [%] | TD | 1.8 | 1.7 | 1.7 | 1.7 | 1.8 | 1.9 | 2.5 |
| Puncture | | 1.3 | 2.1 | 2.7 | 4.2 | 2.6 | 2.2 | 3 |
| resistance [N] | | | | | | | | |
| Density [g/cm³] | | 1.1 | 1.02 | 0.99 | 0.96 | 0.99 | 0.99 | 1.4 |
| Smooth running | | (0) | (+) | (++) | (++) | (+) | (+) | (0) |
| Elasticity | MD | 2900 | 3000 | 3000 | 3200 | 3100 | 3000 | 2900 |
| modulus [N/mm²] | TD | 2800 | 2900 | 3000 | 3100 | 3000 | 3000 | 2800 |
| Elongation | MD | 100 | 98 | 110 | 105 | 99 | 103 | 91 |
| at break [%] | TD | 63 | 60 | 69 | 70 | 61 | 64 | 52 |
| Sealability | | s1 | s1 | s1 | s1 | s1 | s2 | |
| Blister | | q1 | q2 | q2 | q2 | q2 | q2 | q2 |
| producibility | | | | | | | | |
| Notes | | | | | Can still | | | Stretches |
| | | | | | be pressed | | | severely |
| | | | | | through by | | | when |
| | | | | | hand, but | | | pressed |
| | | | | | resistance | | | through, |
| | | | | | very high | | | hence a |
| | | | | | | | | bit more |
| | | | | | | | | difficult |

| | | E8 | E9 | E10 | E11 | CE1 | CE2 |
|---|---|---|---|---|---|---|---|
| Shrinkage | MD | 1.5 | 1.7 | 1.9 | 1.8 | 1.8 | 1.1 |
| 150° C. [%] | TD | 0.9 | 1 | 1.1 | 1.1 | 1.1 | 0.1 |
| Shrinkage | MD | 2.1 | 2.1 | 2.3 | 2.2 | 2.2 | 1.5 |
| 180° C. [%] | TD | 1.6 | 1.6 | 1.8 | 1.9 | 1.7 | 0.5 |
| Puncture | | 2.8 | 2.7 | 2.4 | 2.5 | 7.5 | 6.1 |
| resistance [N] | | | | | | | |
| Density [g/cm³] | | 0.96 | 1.22 | 1.02 | 1 | 0.95 | 1.4 |
| Smooth running | | (0) | (+) | (+) | (0) | (++) | (++) |
| Elasticity | MD | 2900 | 2900 | 3000 | 3100 | 2900 | 4600 |
| modulus [N/mm²] | TD | 2900 | 2900 | 2900 | 3000 | 2800 | 4400 |
| Elongation | MD | 115 | 105 | 90 | 95 | 105 | 115 |
| at break [%] | TD | 85 | 75 | 61 | 62 | 73 | 108 |
| Sealability | | s1 | s1 | s1 | s1 | s1 | s1 |
| Blister | | q2 | q2 | q2 | q2 | q3 | q2 |
| producibility | | | | | | | |
| Notes | | | | Foil | Two-layer | Cannot be | Cannot be |
| | | | | much | structure | pressed | pressed |
| | | | | yellower | AB | through | through |
| | | | | than B2 | | by hand | by hand |

Key to table: Properties according to the invention
Sealability rating:
s1: good to A-PET, adequate to PVC
s2: adequate to A-PET, good to PVC
Blister producibility rating:
q1: producible, but sporadic sorting due to creasing
q2 producible
q3 machine had to be slowed down as more time was needed for sealing

1. A multilayer, coextruded polyester foil comprising an outer layer (A) and a base layer (B), wherein
(I) the outer layer (A) consists to an extent of at least 70% by weight of a polymer fraction which consists to an extent of at least 70% by weight of a copolyester which consists to an extent of 50 mol % of a dicarboxylic acid component and to an extent of 50 mol % of a diol component,
wherein the copolyester derives from polyethylene terephthalate which consists to an extent of 50 mol % of ethylene glycol as diol component and to an extent of 50 mol % of terephthalic acid as dicarboxylic acid component,
in which in total 15 to 50 mol % of the ethylene glycol and/or of the terephthalic acid is replaced by dicarboxylic acid components and/or diol components other than ethylene glycol and/or terephthalic acid;
(II) the base layer (B)
(a) consists to an extent of at least 78% by weight of a polymer fraction which
(i) consists to an extent of at least 70% by weight of a copolyester which consists to an extent of 50 mol % of a dicarboxylic acid component and to an extent of 50 mol % of a diol component,
wherein the copolyester derives from polyethylene terephthalate which consists to an extent of 50 mol % of ethylene glycol as diol component and to an extent of 50 mol % of terephthalic acid as dicarboxylic acid component,
in which in total 2 to 35 mol % of the ethylene glycol and/or of the terephthalic acid is replaced by dicarboxylic acid components and/or diol components other than ethylene glycol and/or terephthalic acid,
(ii) consists to an extent of 0% to 30% by weight of a polymer incompatible with polyethylene terephthalate,
(b) the base layer (B) contains 0% to 7% by weight of a particle having a mean particle diameter of d50≥1 μm, based on the total weight of the base layer (B),
wherein the base layer (B) contains the incompatible polymer as per (ii) and/or the particles as per (b).

2. The polyester foil as claimed in claim 1, wherein the polymer fraction of the outer layer A consists to an extent of at least 85%, by weight of the copolyester.

3. The polyester foil as claimed in claim 1, wherein in the copolyester of the outer layer (A), a total 18 to 40 mol % of the ethylene glycol and/or of the terephthalic acid is replaced by dicarboxylic acid components and/or diol components selected from the group consisting of succinic acid, glutaric acid, pimelic acid, suberic acid, azelaic acid, sebacic acid, isophthalic acid, naphthalenedicarboxylic acid, adipic acid, furandicarboxylic acid, 1,4-cyclohexanedimethanol, diethylene glycol, neopentyl glycol, propanediol and butanediol.

4. The polyester foil as claimed in claim 1, wherein in the copolyester of the base layer (B), a total of 2 to 35 mol % of the ethylene glycol and/or of the terephthalic acid is replaced by dicarboxylic acid components and/or diol components selected from the group consisting of succinic acid, glutaric acid, pimelic acid, suberic acid, azelaic acid, sebacic acid, isophthalic acid, naphthalenedicarboxylic acid, adipic acid, furandicarboxylic acid, 1,4-cyclohexanedimethanol, diethylene glycol, neopentyl glycol, propanediol and butanediol.

5. The polyester foil as claimed in claim 1, wherein the polymer fraction of the base layer B consists to an extent of 0.5% to 30% by weight of a polymer incompatible with polyethylene terephthalate and the base layer B contains 0% by weight of a particle having a mean particle diameter of d50>1 μm; or
the polymer fraction of the base layer B consists to an extent of 0% by weight of a polymer incompatible with polyethylene terephthalate and the base layer B contains 0.2% to 7% by weight of a particle having a mean particle diameter of d50>1 μm; or
the polymer fraction of the base layer B consists to an extent of 4% to 17% by weight of a polymer incompatible with polyethylene terephthalate and the base layer B contains 1.0% to 3.0% by weight of a particle having a mean particle diameter of d50>1 μm.

6. The polyester foil as claimed in claim 1, wherein the incompatible polymer is a polymer and/or copolymer based on ethylene, propylene, cyclic olefins, amides or styrene polymer.

7. The polyester foil as claimed in claim 1, wherein the particles in the base layer B have a mean particle diameter d50 of ≥1.5 μm.

8. The polyester foil as claimed in claim 1, wherein the particles in the base layer B are selected from the group consisting of silicon dioxide, aluminum silicates, aluminum oxide, crosslinked PMMA, barium sulfate, titanium oxide and calcium carbonate, and combinations thereof.

9. The polyester foil as claimed in claim 1, wherein the polyester foil comprises an outer layer C, the base layer B being disposed between the outer layers A and C.

10. The polyester foil as claimed in claim 1, wherein the polyester foil has an overall foil thickness of 8 μm to 25 μm.

11. A process for producing a polyester foil as claimed in claim 1, comprising melting the polymers for the individual layers of the foil in a plurality of extruders, shaping the resulting melts into flat melt films in a multilayer die, pressing the flat melt film through a slot die, and drawing off the pressed flat melt film on a chill roll and one or more takeoff rolls, cooling and solidifying the chilled flat melt film into polyester foil and biaxially orienting, subsequently heat-setting and then winding up the polyester foil, wherein
(I) the outer layer (A) consists to an extent of at least 70% by weight of a polymer fraction which consists to an extent of at least 70% by weight of a copolyester which consists to an extent of 50 mol % of a dicarboxylic acid component and to an extent of 50 mol % of a diol component,
wherein the copolyester derives from polyethylene terephthalate which consists to an extent of 50 mol % of ethylene glycol as diol component and to an extent of 50 mol % of terephthalic acid as dicarboxylic acid component,
in which in total 15 to 50 mol % of the ethylene glycol and/or of the terephthalic acid is replaced by dicarboxylic acid components and/or diol components other than ethylene glycol and/or terephthalic acid;
(II) the base layer (B)
(a) consists to an extent of at least 78% by weight of a polymer fraction which
(i) consists to an extent of at least 70% by weight of a copolyester which consists to an extent of 50 mol % of a dicarboxylic acid component and to an extent of 50 mol % of a diol component,
wherein the copolyester derives from polyethylene terephthalate which consists to an extent of 50 mol % of ethylene glycol as diol component and to an extent of 50 mol % of terephthalic acid as dicarboxylic acid component,
in which in total 2 to 35 mol % of the ethylene glycol and/or of the terephthalic acid is replaced by dicarboxylic acid components and/or diol components other than ethylene glycol and/or terephthalic acid,
(ii) consists to an extent of 0% to 30% by weight of a polymer incompatible with polyethylene terephthalate,
(b) the base layer (B) contains 0% to 7% by weight of a particle having a mean
particle diameter of d50≥1 μm, based on the total weight of the base layer (B), wherein the base layer (B) contains the incompatible polymer as per (ii) and/or the particles as per (b).

12. The process as claimed in claim 11, wherein before the melting of the polymers in the extruders, a particulate polymer which contains the particles having a mean particle diameter of d50>1 μm of the base layer B is produced and said method further comprises mixing the particulate polymer with particle-free polyester of the base layer B during melting.

13. The process as claimed in claim 11, wherein said process further comprises feeding the incompatible polymer of the base layer B into the extruder during melting.

14. A lidding foil for a blister pack comprising the foil as claimed in claim 1.

15. A blister pack consisting of a preshaped film for accommodating solid products and a lidding foil comprised of polyester foil as claimed in claim 1.

16. The polyester foil as claimed in claim 2, wherein the polymer fraction of the outer layer A consists to an extent of at least 90% by weight of the copolyester.

17. The polyester foil as claimed in claim 2, wherein the polymer fraction of the outer layer A consists to an extent of 100% by weight of the copolyester.

18. The polyester foil as claimed in claim 3, wherein in the copolyester of the outer layer (A) a total of 20 to 36 mol % of the ethylene glycol and/or of the terephthalic acid is replaced.

19. The polyester foil as claimed in claim 3, wherein in the copolyester of the outer layer (A) 22 to 34 mol % of the ethylene glycol and/or of the terephthalic acid is replaced.

20. The polyester foil as claimed in claim 4, wherein in the copolyester of the base layer (B) a total of 3 to 18 mol % of the ethylene glycol and/or of the terephthalic acid is replaced.

21. The polyester foil as claimed in claim 4, wherein in the copolyester of the base layer (B), in total 4 to 10 mol % of the ethylene glycol and/or of the terephthalic acid is replaced.

22. The polyester foil as claimed in claim 4, wherein in the copolyester of the base layer (B), in total 5 to 7 mol % of the ethylene glycol and/or of the terephthalic acid is replaced.

23. The polyester foil as claimed in claim 5, wherein the polymer fraction of the base layer B consists to an extent of 2% to 25% by weight of a polymer incompatible with polyethylene terephthalate and the base layer B contains 0% by weight of a particle having a mean particle diameter of d50>1; or
the polymer fraction of the base layer B consists to an extent of 0% by weight of a polymer incompatible with polyethylene terephthalate and the base layer B contains 1.0% to 3.0% by weight of a particle having a mean particle diameter of d50>1 μm; or
the polymer fraction of the base layer B consists to an extent of 12% to 16% by weight of a polymer incompatible with polyethylene terephthalate and the base layer B contains 1.7% to 2.2% by weight of a particle having a mean particle diameter of d50>1 μm.

24. The polyester foil as claimed in claim 6, wherein the incompatible polymer is a polymer and/or copolymer based on a C2/C3, C2/C4, C3/C4 or C2/C3/C4 copolymer, or copolymer based on cyclic olefins.

25. The polyester foil as claimed in claim 6, wherein the incompatible polymer is a norbornene/ethylene and/or tetracyclododecene/ethylene copolymer.

26. The polyester foil as claimed in claim 7, wherein the particles in the base layer B have a mean particle diameter d50 of ≥2 μm and of ≤8 μm.

27. The polyester foil as claimed in claim 7, wherein the particles in the base layer B have a mean particle diameter d50 of ≤6 μm.

28. The polyester foil as claimed in claim 7, wherein the particles in the base layer B have a mean particle diameter d50 of ≤5 μm.

29. The polyester foil as claimed in claim 10, wherein the overall foil thickness is 11 μm to 20 μm.

30. The polyester foil as claimed in claim 10, wherein the overall foil thickness is 13 μm to 18 μm.
